(19) United States
(12) Patent Application Publication
(10) Pub. No.: US 2014/0122126 A1
(43) Pub. Date: May 1, 2014

(54) CLINICAL INFORMATION PROCESSING

(71) Applicant: Health Fidelity, Inc., Palo Alto, CA (US)

(72) Inventor: Daniel J. Riskin, Palo Alto, CA (US)

(21) Appl. No.: 14/066,409

(22) Filed: Oct. 29, 2013

Related U.S. Application Data
(63) Continuation of application No. PCT/US13/67283, filed on Oct. 29, 2013.
(60) Provisional application No. 61/719,561, filed on Oct. 29, 2012.

(51) Int. Cl. G06F 19/00

(52) U.S. Cl. CPC G06F 19/322
USPC 705/3

(57) ABSTRACT

Described herein are methods for processing data in order to assess the likelihood that a patient belongs within a specified cohort. In general, the method may include the steps of receiving a plurality of data elements from multiple data sets, wherein at least a portion of the plurality of data elements are unstructured data elements; and assessing the likelihood that the patient belongs within the specified cohort using at least a portion of the plurality of data elements including at least one unstructured data element. In some embodiments, the method may further include the step of processing the unstructured data elements. In some embodiments, the method may further include the step of querying at least a portion of the plurality of data elements including at least one unstructured data element to assess the likelihood that the patient belongs within the specified cohort.

### CROSS REFERENCE TO RELATED APPLICATIONS

This application claims benefit of and priority to U.S. Provisional Patent Application Ser. No. 61/719,561 filed Oct. 29, 2012, and is a continuation of PCT application Ser. No. PCT/US 13/67283 filed Oct. 29, 2013, both of these applications are hereby incorporated herein by reference. This application is related to International Patent Application No. PCT/US12/27767, titled “METHODS FOR PROCESSING PATIENT HISTORY DATA”, filed on Mar. 5, 2012 which is herein incorporated by reference. This application is related to U.S. patent application Ser. No. 14/066,313 filed Oct. 29, 2013 which is hereby incorporated herein by reference.

This Provisional patent application may also be related to Provisional Patent Application No. 61/684,733, titled “SYSTEMS AND METHODS FOR PROCESSING PATIENT INFORMATION”, filed on Aug. 18, 2012 which is herein incorporated by reference.

All patent applications cited in this specification are herein incorporated by reference in their entirety to the same extent as if each individual publication or patent application was specifically and individually indicated to be incorporated by reference.

### BACKGROUND

1. Field of the Invention

Various embodiments of the invention are in the field of processing clinical information, for example, processing unstructured and discrete healthcare data.

2. Related Art

Quality improvement and cost reduction efforts are founded on the paradigm: measure, intervene, and measure again. The measurement steps, sometimes called quality measures, require significant individual and population-based patient data. Whether the data are originally collected for revenue cycle management, compliance, analytics, or other efforts, the ultimate goal of data collection in healthcare is improved quality, reduced costs, or both.

Current methods of data extraction, annotating, and coding from the healthcare workflow are typically manual. The physician may use dropdowns, textboxes, or templates in an application to code a medical problem. A billing coder may review a chart and assign billing codes. A quality department may be tasked with extraction of information from charts. A quality team may be tasked with seeing every patient every day to manually document quality measures in an electronic record. Conventional processes of data extraction in healthcare are slow, expensive and often ineffective.

Interestingly, the majority of information that ultimately becomes coded via these manual processes already exists within the patient record. Most independent estimates demonstrate that roughly 80% of meaningful information exists unstructured within the patient record while only 20% of the meaningful information exists in a discrete annotated form usable for downstream analytics and quality improvement. The unstructured information typically resides in medical narratives, often long text notes that are typed, template-driven, or dictated for every encounter on every patient, every day.

When physicians, researchers, or administrators want to understand a patient, drive resources for a patient, treat a patient, or assess a population of patients, they typically assign a patient to a given cohort or set of cohorts. A cohort is an individual or group of individuals that meet a specific characteristic or set of characteristics. For example, a patient may be considered for inclusion in the cohort of poorly controlled diabetics, which may define a treatment paradigm. A patient may be considered for inclusion within a research trial cohort, which may define a research opportunity. A patient may be found to exist within a cohort requiring screening mammography, which may indicate preventive measures. Throughout healthcare, recognizing patient cohorts within a specified population is foundational to high quality care and is one of the greatest challenges.

### SUMMARY OF THE DISCLOSURE

Described herein are methods for processing data to assess the likelihood that a patient belongs within a specified cohort. In general, the methods described herein may include the steps of receiving a plurality of data elements from multiple data sets, wherein at least a portion of the plurality of data elements are unstructured data elements; and assessing the likelihood that the patient belongs within the specified cohort using at least a portion of the plurality of data elements including at least one unstructured data element. In some embodiments, non-inclusion in the specified cohort represents exclusion from the specified cohort. In some embodiments, the specified cohort includes a negative characteristic and is equal to exclusion from a related cohort.

In some embodiments, the method may further include the step of processing the unstructured data elements. In some embodiments, the step of processing the unstructured data elements includes the steps of scanning the unstructured data elements using a natural language processing (NLP) engine to identify a plurality of concepts within a plurality of distinct contexts; and structuring the unstructured data elements by creating aggregations of the concepts and annotating relationships between the concepts one or more of a clinical model, an ontology, and/or a lexicon. Use of the clinical model, ontology and/or lexicon results in and allows for normalizing extracted concepts using a controlled vocabulary. In some embodiments, the structuring the unstructured data elements step further includes structuring the unstructured data by mapping the data to the clinical model and providing post-coordinated content. In some embodiments, the structuring the unstructured data set step further includes structuring the unstructured data by mapping the data to the ontology and/or lexicon and providing pre-coordinated content.

In some embodiments, the steps of scanning the unstructured data and structuring the unstructured data are data processing steps, and the data processing is a component of at least one of an application, workflow, and/or system. In some embodiments, the data processing occurs in real-time. In some embodiments, at least one step in data processing occurs as a delayed process.

In some embodiments, the assessing step includes assessing the likelihood that the patient belongs within the specified cohort using at least one processed unstructured data element. In some embodiments, the unstructured data elements are from one or more of an electronic health record, data warehouse, data repository, health information exchange, hospital data system, and/or non-hospital data system.

In some embodiments, the step of assessing the likelihood that a patient belongs within a specified cohort includes assessing the likelihood based on predetermined likelihood criteria. In some embodiments, the step of assessing the likelihood that a patient belongs within a specified cohort includes determining a likelihood score that a patient belongs within a specified cohort.

In some embodiments, the step of assessing the likelihood that a patient belongs within a specified cohort includes determining if the data elements agree on patient placement within the specified cohort. In some embodiments, the step of assessing the likelihood that a patient belongs within a specified cohort includes determining that the patient is within the specified cohort if the data elements agree that the patient is within the specified cohort.

In some embodiments, the step of assessing the likelihood that a patient belongs within a specified cohort includes determining that the patient is not within the specified cohort if the data elements agree that the patient is not within a specified cohort. In some embodiments, the step of assessing the likelihood that a patient belongs within a specified cohort includes determining that the patient is possibly within the specified cohort if the data elements do not agree on whether the patient is within a specified cohort. In some embodiments, the method further includes the step of receiving a plurality of data elements from additional data sets if the data elements do not agree on whether the patient is within a specified cohort. In some embodiments, the method further includes the step of receiving a plurality of data elements from additional data sets based on specific likelihood scores to further assess the likelihood that a patient belongs within the specified cohort. In some embodiments, the method further includes the step of performing a manual review of the data elements if the data elements do not agree on whether the patient is within a specified cohort. In some embodiments, the method further includes the step of performing a manual review of the data elements based on specific likelihood scores to further assess the likelihood that a patient belongs within a specified cohort.

In some embodiments, the step of assessing the likelihood that a patient belongs within a specified cohort is performed using a single data element. In some embodiments, at least a portion of the plurality of data elements include processed unstructured data elements. In some embodiments, the processed unstructured data elements comprise patient encounter narratives entered from at least one of transcription, typed data entry, templated data entry, pen-based data entry, tablet based data entry, mobile data entry, other suitable forms of data entry, and/or a combination thereof. In some embodiments, at least a portion of the plurality of data elements includes discrete data elements. In some embodiments, the discrete data elements comprise at least one of claims data, administrative data, EHR discrete data, hospital software system data, software system data from outside a hospital, and health information exchange data. In some embodiments, at least a portion of the discrete data elements have been previously collected. In some embodiments, the step of assessing the likelihood that the patient belongs within the specified cohort is performed using a combination of at least one unstructured data element and at least one discrete data element. In some embodiments, the step of assessing the likelihood that a patient belongs within a specified cohort includes determining if the combination of unstructured data elements and discrete data elements agree on patient placement within the specified cohort.

In some embodiments, multiple patients are assessed concurrently. In some embodiments, multiple cohorts are specified concurrently. In some embodiments, multiple patients and multiple specified cohorts are assessed concurrently.

In some embodiments, relative probabilities for inclusion in two or more cohorts may be calculated. For example, there may be an 80% probability of inclusion in cohort A versus a 10% inclusion in cohort B. As another example, there may be a 50% higher likelihood of inclusion in cohort A versus cohort B.

In some embodiments, the method further includes the step of using an algorithm to weight the data elements used to determine the likelihood that the patient belongs within the specified cohort.

In some embodiments, the method includes use of related concepts or context to support a concept as meaningful or important. For example, within a narrative or patient longitudinal record, the concept of pneumonia may be noted. This may be treated differently if other concepts within the record support pneumonia, such as high white count lab test, lung infiltrates on chest x-ray, fever, and/or chest rales. As another example, pneumonia may occur within the context of patient assessment, which may suggest stronger support than mention within the context of past medical history within a narrative. A supported concept of pneumonia may lead to inclusion of a patient within a cohort for active pneumonia care whereas pneumonia occurring without support may not lead to inclusion within that cohort.

In some embodiments, a combination of associated concepts and context may be used to determine level of support for a concept. For example, pneumonia appearing within the context of history of present illness and appearing with mildly supporting concepts such as fever and colored sputum may be adequate for cohort inclusion whereas appearance within the context of past medical history with the same associated concepts of fever and colored sputum may not be adequate for inclusion in the cohort. In some embodiments, concepts and context carry weights and an algorithm is used to determine inclusion within a cohort. In some embodiments, weights for concepts and contexts are specific to a given cohort, concept, and/or association.

In some embodiments, a cohort may be used to support downstream cohort allocation. For example, inclusion in the active pneumonia cohort may be used as a criterion for inclusion in other cohorts. Examples of such downstream cohorts may include patients that will be billed for pneumonia, patients who are actively being treated for pneumonia, and patients who have frequent pneumonia and are at particularly high risk for hospital readmission.

In some embodiments, supported concepts may be used when assigning patients to risk stratification cohorts. For example, a patient with supported pneumonia and supported heart failure may be a better candidate for a high risk 30 day hospital readmission cohort than a patient with non-supported pneumonia and heart failure. In the latter case, the pneumonia and heart failure may be not current or may not be active problems in the recent encounter. Supporting concepts may help to assess how important or meaningful a concept is within a given document or longitudinal record.

In some embodiments, a concept may be considered supported if multiple supporting concepts provide adequate support based on a support algorithm. For example, the concept pneumonia may require a level of support of 2.0 to be considered supported. An algorithm may require supporting concepts exist within the same narrative, paired claims data, or longitudinal record. If the algorithm requires support within the same narrative and if the narrative includes the concepts fever, high white cell count, and/or chest rales, each of which is associated with pneumonia, then these concepts may be considered supportive of pneumonia. If each concept is assigned a support coefficient for pneumonia, for example fever=0.5, white cell count=1.0, and chest rales=1.3 for pneumonia, then the level of support for pneumonia in a given encounter or longitudinal record may be 0.5+1.0+1.3=2.8. Since 2.8 is greater than the required level of support of 2.0, the concept of pneumonia may be considered supported based on this algorithm.

In some embodiments, a database of concept associations may be created, to demonstrate associations between concepts. For example, the database may include pneumonia and associated concepts such as fever, high white cell count, and/or chest rales. The database may also include levels of support associated with each concept. For example, fever has a support coefficient of 0.5 in support of pneumonia.

In some embodiments, the concept association database may be fully or partially machine learned. The learning step may include use of at least one of: processed unstructured data, electronic health record discrete data, and claims data. Collocation of concepts within an encounter may be used to determine likely associations and strength of associations. For example, pneumonia and fever may occur together in 10,000 narrative encounters out of a million. The frequency of the concept pneumonia in the data set may be 2%. The frequency of the concept fever in the data set may be 5%. Thus, expected co-occurrence of pneumonia and fever would be 2% times 5%, or 0.1%. The actual co-occurrence in this example is 10,000 out of a million, or 1%. Thus, actual co-occurrence is equal to 10 times the expected co-occurrence. The discrepancy between actual and expected co-occurrence may be used with other data elements to determine the strength of association of concepts. The logic may be configured to define associations based on differences between actual and expected co-occurrence. A chi squared or other method may be used to define unexpected co-occurrence. More advanced calculations may consider and/or determine Bayesian conditional probabilities. For example, the presence of a fever may change the probability of pneumonia. The probability of a patient being in a cohort may be dependent on a positive test result, a false positive rate for the test, and a probably of the patient being in the cohort prior to considering the test information. Other data elements to support concept association may include collocation within claims data, proximity of occurrence within narrative content, and collocation within medical literature. Strength of association of concepts may be used to determine the level of support of one concept for another. For example, a software application may require calculating whether a concept such as appendicitis is adequately supported in a document or longitudinal record. A sufficient weighting of associated concepts, such as fever and abdominal pain, may be used to determine whether the concept appendicitis is adequately supported.

In some embodiments, a method for processing data in order to assess the likelihood that a patient belongs within a specified cohort includes the steps of receiving a plurality of data elements from multiple data sets, wherein at least a portion of the plurality of data elements are unstructured data elements; and querying at least a portion of the plurality of data elements including at least one unstructured data element to assess the likelihood that the patient belongs within the specified cohort.

In some embodiments, the plurality of data elements queried includes at least one previously processed unstructured data element. In some embodiments, the step of querying a portion of the plurality of data elements includes using similar query techniques on unstructured data elements, processed unstructured data elements, discrete data elements, or a combination of data elements from different data sources.

In some embodiments, the method further includes the step of building a query on data elements from a data warehouse. In some embodiments, the method further includes the step of querying an index of a data warehouse.

In some embodiments, the step of querying a portion of the plurality of data elements includes querying the at least one unstructured data element using an ontology. In some embodiments, the ontology is SNOMED. In some embodiments, the step of querying a portion of the plurality of data elements includes querying the unstructured data element(s) using an ontologic module. An ontologic module is a subset or full set of an ontology. In some embodiments, the ontologic module is a set of associated concepts within an ontology. In some embodiments, the step of querying a portion of the plurality of data elements includes querying the unstructured data element(s) using term matching. In some embodiments, the step of querying a portion of the plurality of data elements includes querying the unstructured data element(s) using processed terms mapped to a lexicon. In some embodiments, the lexicon is one or more of ICD-9, ICD-10, RxNorm, CPT-4, and/or LOINC. In some embodiments, the step of querying a portion of the plurality of data elements includes querying the unstructured data element(s) using at least one annotation within a clinical model. In some embodiments, the step of querying a portion of the plurality of data elements includes querying the unstructured data element(s) using a combination of at least one of keyword, lexicon, ontology, and/or clinical model annotation. In some embodiments, the step of querying a portion of the plurality of data elements includes querying an index which includes annotations with at least one of a text term, clinical model, lexicon, and/or ontology

In some embodiments, a method for processing data in order to assess the likelihood that a patient belongs within a specified cohort further includes the step of determining a probability that the data elements agree on patient placement within the specified cohort. In some embodiments, at least a portion of the plurality of data elements includes both unstructured data elements and discrete data elements. In some embodiments, the determining step includes determining a probability that the unstructured data elements and the discrete data elements agree on patient placement within the specified cohort.

In some embodiments, the method further includes the step of determining a likelihood threshold such that at least a portion of patients are automatically included within the specified cohort. In some embodiments, the method further includes the step of determining a likelihood threshold such that at least a portion of patients are automatically excluded from the specified cohort. In some embodiments, the method further includes the step of applying additional logic when a patient is not automatically included within or excluded from the specified cohort. In some embodiments, the step of applying additional logic includes performing a manual review of a portion of the plurality of data elements associated with a subset of patients to assess the likelihood that patients within the subset of patients belong within the specified cohort.

In some embodiments, a method for processing data in order to assess the likelihood that a patient belongs within a specified cohort includes the steps of receiving a plurality of data elements from multiple data sets, wherein at least a portion of the plurality of data elements are unstructured data elements; assessing the likelihood that the patient belongs within the specified cohort using at least a portion of the plurality of data elements including at least one unstructured data element; assigning at least one patient to the specified cohort; and mining data associated with the patient(s) assigned to the specified cohort.

In some embodiments, the specified cohort is specific to a diagnosis or condition. In some specific embodiments, the specified cohort is specific to a diagnosis or condition and the data mining step further comprises aligning population-based management to the diagnosis or condition. In some specific embodiments, the specified cohort is specific to a diagnosis or condition and the data mining step further comprises identifying hospital or health system-based quality improvement interventions for the diagnosis or condition. In some embodiments, the specified cohort inclusion criteria include at least one aspect of medication compliance. In some specific embodiments, the specified cohort inclusion criteria includes at least one aspect of medication compliance and the data mining step further comprises identifying quality improvement interventions for medication compliance. In some embodiments, the specified cohort inclusion criteria include at least one documentation feature. In some specific embodiments, the specified cohort inclusion criteria includes at least one documentation feature and the data mining step further comprises supporting clinical documentation improvement. In some embodiments, the specified cohort inclusion criteria include at least one clinical feature. In some specific embodiments, the specified cohort inclusion criteria include at least one clinical feature and the data mining step further comprises supporting clinical decision making. In some embodiments, the specified cohort inclusion criteria include at least one aspect of revenue cycle claim response. In some embodiments, the specified cohort inclusion criteria include at least one aspect of revenue cycle claim response and the data mining step further comprises identifying ways to avoid future revenue cycle claim rejection. In some embodiments, the specified cohort inclusion criteria include at least one adverse event. In some specific embodiments, the specified cohort inclusion criteria include at least one adverse event and the data mining step further comprises determining factors associated with adverse events. In some embodiments, the specified cohort inclusion criteria include at least one aspect of a treatment algorithm. In some specific embodiments, the specified cohort inclusion criteria include at least one aspect of a treatment algorithm and the data mining step further comprises assessing which treatment algorithms or aspect of a treatment algorithm leads to a preferred outcome. In some embodiments, the data mining step further comprises assessing which specific patient characteristics support a treatment algorithm or aspect of a treatment algorithm to promote a preferred outcome.

In some embodiments, the data associated with the patient(s) assigned to the specified cohort are used to define standard of care. In some embodiments, the data associated with the patient(s) assigned to the specified cohort are used for improved care quality or reduced costs. In some embodiments, the data associated with the patient(s) assigned to the specified cohort are used for reporting compliance. In some embodiments, the data associated with the patient(s) assigned to the specified cohort are used for research. In some embodiments, the data associated with the patient(s) assigned to the specified cohort are used for cost effectiveness measurement. In some embodiments, the data associated with the patient(s) assigned to the specified cohort are used to simulate a clinical trial. In some embodiments, the data associated with the patient(s) assigned to the specified cohort are used at the point of care to define best practices. In some embodiments, the data associated with the patient(s) assigned to the specified cohort are used to improve administrative efficiency. In some embodiments, the data associated with the patient(s) assigned to the specified cohort are used to improve claims efficiency.

Various embodiments of the invention include a method for processing data in order to assess the likelihood that a patient belongs within a specified cohort, the method comprising: receiving a plurality of data elements from multiple data sets, wherein at least a portion of the plurality of data elements are unstructured data elements; and assessing the likelihood that the patient belongs within the specified cohort using at least a portion of the plurality of data elements including at least one unstructured data element.

Various embodiments of the invention include a method for recognizing a set of associated concepts comprising the steps of: scanning a set of narrative documents using a natural language processing (NLP) engine to identify a plurality of concepts; normalizing extracted concepts using a controlled vocabulary; determining actual and expected co-occurrence of potentially associated concepts; and defining associations based on an algorithm that includes difference between actual and expected co-occurrence.

Various embodiments of the invention include a method for processing data in order to assess the likelihood that a patient belongs within a specified cohort, the method comprising: receiving a plurality of data elements from multiple data sets, wherein at least a portion of the plurality of data elements are unstructured data elements; and querying at least a portion of the plurality of data elements including at least one unstructured data element to assess the likelihood that the patient belongs within the specified cohort.

Various embodiments of the invention include a method for processing data in order to assess the likelihood that a patient belongs within a specified cohort, the method comprising: receiving a plurality of data elements from multiple data sets, wherein at least a portion of the plurality of data elements are unstructured data elements; assessing the likelihood that the patient belongs within the specified cohort using at least a portion of the plurality of data elements including at least one unstructured data element; assigning at least one patient to the specified cohort; and mining data associated with the patient(s) assigned to the specified cohort.

Various embodiments of the invention include a system configured for assessing the likelihood that a patient belongs within a specified cohort, the system comprising: a content receiver configured for receiving a plurality of data elements from multiple data sets, wherein at least a portion of the plurality of data elements are unstructured data elements; and a cohort identifier configured for assessing the likelihood that the patient belongs within the specified cohort using at least a portion of the plurality of data elements including at least one unstructured data element.

Various embodiments of the invention include a system configured for recognizing a set of associated concepts, the system comprising: a natural language processing engine configured for scanning a set of narrative documents to identify a plurality of concepts; an inference engine configured for normalizing extracted concepts using a controlled vocabulary, determining actual and expected co-occurrence of potentially associated concepts, and defining associations based on an algorithm that includes difference between actual and expected co-occurrence.

Various embodiments of the invention include a system configured for assessing a likelihood that a patient belongs within a specified cohort, the system comprising: a content receiver configured for receiving a plurality of data elements from multiple data sets, wherein at least a portion of the plurality of data elements are unstructured data elements; and a content processor configured for querying at least a portion of the plurality of data elements including at least one unstructured data element to assess the likelihood that the patient belongs within the specified cohort.

Various embodiments of the invention include a system configured for assessing the likelihood that a patient belongs within a specified cohort, the system comprising: a content receiver configured for receiving a plurality of data elements from multiple data sets, wherein at least a portion of the plurality of data elements are unstructured data elements; a cohort identifier configured for assessing the likelihood that the patient belongs within the specified cohort using at least a portion of the plurality of data elements including at least one unstructured data element, and assigning at least one patient to the specified cohort; and a content processor configured for mining data associated with the patient(s) assigned to the specified cohort.

### BRIEF DESCRIPTION OF THE DRAWINGS

FIG. 1 illustrates a system configured for processing data, according to various embodiments of the invention;

FIGS. 2A and 2B illustrate a first method for processing data in order to assess the likelihood that a patient belongs within a specified cohort, according to various embodiments of the invention;

FIG. 3 illustrates a data flow as may occur during the methods illustrated in FIGS. 2A and 2B, according to various embodiments of the invention;

FIG. 4 illustrates logic to determine likelihood that a patient meets inclusion or exclusion criteria for a specified cohort, according to various embodiments of the invention;

FIG. 5 illustrates another method for processing data in order to assess the likelihood that a patient belongs within a specified cohort, according to various embodiments of the invention; and

FIG. 6 illustrates another method for processing data in order to assess the likelihood that a patient belongs within a specified cohort and mining the data associated with the patient(s) assigned to the specified cohort, according to various embodiments of the invention.

### DETAILED DESCRIPTION

The following description of some embodiments of the invention is not intended to limit the invention to these embodiments, but rather to enable any person skilled in the art to make and use this invention. Disclosed herein are systems and methods for processing data in order to assess the likelihood that a patient belongs within a specified cohort.

A foundational and revolutionary approach for the use processed unstructured data in healthcare is cohort identification. A cohort is a group of individuals that share a common characteristic or characteristics. By automatically identifying common patient characteristics through unstructured data in a robust and consistent way, cohorts may be easily and accurately identified. Cohorts underlie measurement of quality, analysis of research outcomes, determination of treatment algorithm, and countless other medical paradigms. A generalist approach to using processed unstructured data to identify cohorts supports generation of applications and revolutionizes a broad array of previously manual, slow, expensive, and inaccurate processes.

The methods described herein may be used for the classification of patients and cohort identification. Cohort identification can provide a robust platform able to power applications. In particular cohort identification algorithms can power healthcare applications to address quality measures, quality improvement, quality reporting, revenue cycle management, clinical research, standard of care definition, data-driven healthcare, identification of best clinical approach for a complex patient, clinical trial recruitment, clinical trial performance, real time data-driven clinical trial performance, compliance challenges such as meaningful use, accountable care, ICD-10 conversion, and/or other applications in healthcare. In some embodiments, cohort identification supports broad downstream utility for disease management, population health, local and regional quality improvement, efficiency programs, research, comparative effectiveness, and/or other healthcare applications. Cohort identification may itself be an application or part of an application.

Through cohort identification, the methods described herein can provide advanced analytic tools. In some embodiments, real-time or delayed assessment identifies patients with similar characteristics such as underlying clinical condition, reason for clinical encounter, manner of treatment, complications experienced, outcome of interventions, and/or a combination thereof. Real-time analysis may support clinical decision-making or other decision-making within the healthcare workflow. Timely assessment may support broad applications beyond the point of care.

Common features applicable to specific cohorts may be evaluated, such as diabetics with poor clinical outcome, patients who no longer receive care within a given institution, claims rejection, and worse outcome for a given condition than predicted. Cohorts may be combined to yield a small subset of patients that is high yield for intervention, such as diabetic hypertensive patients with multiple recent hospital admissions.

### DEFINITIONS

Post-coordinated content may be defined as content including a set of elements that make up a given clinical assertion. For example, primaryTerm ulcer, bodyLocation leg, acuity chronic may represent post-coordinated content. Post-coordinated output may also be known as post-coordinated terms, post-coordinated content, individual components, and atomic representation of a concept. Pre-coordinated content may be defined as content including coded values related to the clinical assertion. For example, the ICD-9 code for chronic leg ulcer may represent pre-coordinated content. Pre-coordinated content may also be known as codes, coded content, and pre-coordinated terms. An ontology may be defined as a rigorous and exhaustive organization of a knowledge domain that is usually hierarchical and contains relevant entities and their relations. For example, an ontology may include a code for leg ulcer, a code for chronic leg ulcer, and an association showing that leg ulcer is a parent of chronic leg ulcer. An ontology may be a formal representation of the knowledge by a set of concepts within a domain and relationships between those concepts. It may be used to reason about the properties of that domain. An example of an ontology is SNOMED. A lexicon may be defined as a formal representation of language. A lexicon may be distinguished from an ontology in that an ontology contains associations between terms. Examples of lexicons include International Classification of Diseases (ICD), ICD-9, ICD-10, Current Procedural Terminology (CPT), CPT-4, Logical Observation Identifiers Names and Codes (LOINC), and RxNorm. Terminology is a system of terms belonging or peculiar to a science, art, or specialized subject. Examples of terminologies include ontologies and lexicons.

Structured content may refer to several forms of structure. Examples of structure include encoding, annotating, and ordering. An example of encoding is representation of leg ulcer with a code. An example of annotating is representing that leg is a bodyLocation. An example of ordering is preceding a set of information with a category “medications”. Narrative content is information related to a patient encounter that is written in medical language. An example is “Patient X is a 57 year old man who presents complaining of right leg pain.” Narrative content may also be known as narrative note, patient note, clinical note, encounter note, unstructured data, and/or a combination thereof. Structured content may also be known as structured output, structured note, and structured data.

Normalized content refers to a concept or concepts which may appear in different formats, but where a code demonstrates that the concept or concepts are the same or similar. For example, type II diabetes mellitus and diabetes mellitus type II may be normalized to a single code within ICD-9. These concepts are the same, though may appear in different formats and it is thus appropriate that a code would normalize the formats to a single concept. As another example, left open femur fracture and open femur fracture may be useful to maintain separately, which may be done in ICD-10, where each concept exists as different code. But, it may be beneficial for a downstream application to recognize that the concepts are similar or the same for that application use case. In this circumstance, it may be beneficial to normalize both to ICD-9 in which body side is not included and both concepts would be normalized to and represented by the exact same code.

Data elements are items within data sets. As an example, 51 years old, diabetes, insurance claim rejection, blood pressure, and hospital readmission may be considered to be data elements residing within discrete data fields or within unstructured text. Unstructured data may refer to unstructured content. Examples may include narrative text notes or brief text phrases which lack or have minimal encoding and annotation. Processed unstructured data may refer to data which has undergone transformation. Unstructured data which has been annotated by natural language processing would be considered processed unstructured data. As an example, text may be identified as belonging to a specific category, concepts may be coded, and terms may include annotations such as medication, bodyLocation, acuity, and other associated concepts. Discrete data may be data elements captured and stored individually. Discrete data elements may reside within administrative data, claims data, EHR data, or other discretely maintained data stores. Discrete data may be manually entered, such as via a dropdown or search box. An example of claims data may include an ICD-9 code for diabetes listed as a discrete item within an insurance claim. An example of administrative data may be a yes/no checkbox on whether a patient meets a quality measure such as deep vein thrombosis prophylaxis. An example of EHR discrete data may include an item hypertension on a problem list, which may be stored as a discrete data element as text or code. Claims data, administrative data, and EHR discrete data are all forms of discrete data. Narrative notes within an EHR are most often stored as text within the EHR and are considered unstructured data. The narrative note may be associated with several individual codes, which would be considered EHR discrete data associated with the narrative note. An example would be a long narrative note containing 50 to 60 concepts that are not annotated or machine readable associated with a list of 4 ICD-9 code that are used for billing or claims. The 4 ICD-9 codes may represent EHR discrete data, while the 50 to 60 concepts within the narrative note may represent unstructured data currently unavailable for machine based analytics.

Clinical modeling is formal representation of data elements. Modifying a clinical assertion may be known as changing the meaning. For example, adding the term “no” to “cancer” would change the meaning from “cancer” to “no cancer”. Qualifying a clinical assertion may be known as adding to the meaning. For example, adding the term “type 2” to “diabetes” would clarify the meaning from “diabetes” to “type 2 diabetes”. XML is extensible markup language. An element may be a structured data element. Elements may qualify or modify other elements. For example, a problem clinical assertion may have elements “diabetes” and “250.00”, each of which provides further information related to that clinical assertion. A property may be defined as an element that qualifies or modifies a clinical assertion. For example, diabetes may be labeled as a primary term for a problem clinical statement and 250.00 may be labeled as an ICD-9 code for the same problem clinical statement. The labels “primaryTerm” and “ICD-9” may be the properties and “diabetes” and “250.00” may be the property values. In general, a label conveys meaning and the specific term used for the label may be substituted with a different term with similar meaning. For example, diabetes may be labeled with primaryTerm or with another concept that conveys similar meaning in this context, such as problem, disease, disorder, or a custom term designed to convey clinical meaning attached to that clinical assertion element. An annotation may be a data element that adds content or context to another data element. For example, an element may annotate another data element by qualifying or modifying it, or a label may be used to annotate or further describe a data element. A label may be an item within a clinical model used to offer further content or context to a data element. For example, hypertension may be labeled as the primary term for a problem or Tylenol may be labeled as the primary term for a medication. The clinical statement for hypertension may be labeled a problem. A label may represent a specialized annotation used within a schematic representation of knowledge. Specific labels described herein are intended to provide illustration of concepts and not narrow potential methods of annotation. A clinical model may be a schematic representation of knowledge within the healthcare domain.

As an example, the concept acute bleeding duodenal ulcer may be processed using a plurality of methods to make it usable for downstream processing. A pre-coordinated representation of the concept may include an ICD-9 code, ICD-10 code, SNOMED code, or a combination thereof. Labeling the concept with an accurate code or codes may be described as terminology mapping. A post-coordinated representation of the concept may align with a clinical model. An example may be a clinical assertion labeled problem, with data elements include primaryTerm ulcer, bodyLocation duodenum, acuity acute, and/or associatedProblem bleeding. A clinical model may include varying levels of detail in knowledge representation and may convey concepts in term labels which are more important than the naming convention itself.

A cohort may be defined generally as an individual or group of group of individuals that meet a specific characteristic or characteristics. In some embodiments, a cohort may be a group of people that share a common demographic, such as age. In some embodiments, a cohort may be a group of people that share an underlying clinical condition or set of clinical conditions, such as obesity or smoking status. In some embodiments, a cohort may be a group of people that share a diagnosis, such as diabetes or hypertension. In some embodiments, a cohort may be a group of people that have received similar care, such as a medication, procedure, operation, or quality improvement intervention. In some embodiments, a cohort may be a group of people that share a specific clinical outcome, such as improvement, worsening, readmission, extensive care requirements, or complication. In some embodiments, a cohort may be a group of people that share any other suitable quality or experience. In some embodiments, a cohort may be a group that share multiple common feature or set of features. In some embodiments, a cohort may be a group that is included in a set of cohorts, excluded from a set of cohorts, or a combination thereof. Many forms of cohorts are used daily in the practice, administration, and improvement of healthcare. Cohorts may be defined by a given clinical condition, supporting quality improvement of that condition. An example would be finding all complicated diabetics within a medical practice to support quality intervention and to support tracking outcomes in this at-risk patient population. Cohorts may be defined by a quality measure, such as identifying a cohort of inadequately treated hypertensive individuals (patients with diagnosed hypertension, but with ongoing high blood pressure despite treatment) to assist in intervening and improving hypertensive quality metrics. Cohorts may be defined by an efficiency criterion, such as those patients that are high resource utilizers and might be well targeted for more outpatient support. Cohorts may be defined by an administrative criterion, such as those patients with claims submitted and rejected that can provide insight into patterns of failed submission and more accurate and targeted claims processes. Cohorts may be defined by those receiving a specific intervention to retrospectively assess outcome and understand efficacy. Cohort identification, while largely manual and inaccurate today, underpins much of healthcare practice and improvement.

A patient may belong within a cohort, may not belong within a cohort, or it may be unknown whether the patient belongs within the cohort. These concepts may also be referenced as a patient being included within a cohort, excluded from a cohort, or inclusion being unknown. For example, a patient with a hemoglobin A1C of 8, an abnormal test result which is a known marker for diabetes, may be said to belong within a diabetes cohort. A patient with multiple normal blood glucose measurements and no active treatment for diabetes may be said to be excluded from a diabetes cohort. A patient who has not been studied or with information unavailable may be said to be unknown how the patient relates to cohort inclusion.

A cohort may include a negative condition. An example would be a cohort defined as patients who are not smokers. A patient included in this cohort would be excluded from a cohort defined as patients who are smokers. In this way, a cohort may be defined such that inclusion in that cohort represents exclusion in another cohort. Assessing cohort inclusion may as easily reference assessing exclusion from another cohort. Thus, assessment of cohort inclusion is used throughout this application to represent assessment for either cohort inclusion or exclusion.

A data set may be defined as broadly as a single data point or data element. In some embodiments, a data set may include a plurality of data points or elements. A data set may also be known as data. A data feed may be a data set provided by a single source. A data feed may also be known as a data stream. In the methods described herein, in some embodiments, data or a data set may be received from a single source. Alternatively, in some embodiments, data or a data set may be received from a combination of multiple sources.

These definitions of terms listed here, and throughout this specification, are for clarification purposes only and are not intended to limit the scope of these terms.

Cohort Usage Examples

In some embodiments, a cohort represents a group of people that share a specific patient outcome or result. In these embodiments, differing cohorts may have received different care prior to the outcome. A cohort analysis may be performed in order to evaluate differential results using differential intervention. As examples, cohorts based on outcomes may include patients with infection after knee replacement, patients with no recurrence after colon cancer treatment, and individuals with medical claims successfully processed. As examples, cohorts based on results may include patients with high blood pressure, patients with lung cancer based on pathology, and individuals with poor exercise tolerance.

In some embodiments, a cohort may represent a group of people that share a specific disease state. In this embodiment, differing cohorts may have different outcome using the same or differing interventions. A cohort analysis may be performed in order to evaluate differential results within a disease state using differential intervention. For example, a cohort may be individuals with diabetes. A cohort analysis may compare the intersection of a cohort with diabetes and the cohort with complications versus the intersection of a cohort with diabetes and a cohort without complications.

In some embodiments, a cohort may represent group of people that have experienced hospital readmission or another undesirable outcome. In this embodiment, differing cohorts may have different outcomes using the same or differing interventions. A cohort analysis may be performed in order to evaluate differential undesirable outcome results using differential intervention. For example, a hospital attempting to reduce its rate of 30 day readmission may attempt to define a cohort of patients that is at high risk for 30 day readmission or may study a cohort of patients that has experienced 30 day readmission versus a matched cohort that did not experience 30 day readmission.

In some embodiments, a cohort may represent group of people that have experienced low utilization, wellness, or another desirable outcome. In this embodiment, differing cohorts may have different outcomes based on differing characteristics. A cohort analysis may be performed in order to evaluate differential outcomes based on differing characteristics or interventions. For example, two matched cohorts with similar demographics and comorbidities where one was healthy during a period and one was ill may be compared against each other.

In some embodiments, a cohort may represent a group of people that have experienced an adverse event. In this embodiment, differing cohorts may have different outcomes using medication or other intervention applied or a combination thereof. A cohort analysis may be performed in order to evaluate differential adverse event rates using differential intervention. For example, a pharmaceutical company may compare a cohort of patients that used a medication and experienced severe headache with a cohort of patients that used a medication and did not experience an adverse effect.

In some embodiments, a cohort may represent a group of people that have experienced a specific payer response to billing. In this embodiment, differing cohorts may have different outcomes based on claims submission pattern. A cohort analysis may be performed in order to evaluate payer response using differential submission pattern. For example, a revenue cycle department may compare patients that were rejected for payment versus those that were not. Such analysis may include segmentation by payer, clinical characteristics, and/or claim characteristics.

In some embodiments, a cohort may be a quality measure, a diagnosis, a sign, a symptom, a result, an intervention, a clinical outcome, a financial outcome, another clinical feature, a demographic feature, a plurality of one of these features, or a combination of these features. For care improvement, it may be useful to find all women who meet criteria for screening mammography who have not had a recent mammogram. For pharmaceuticals, it may be useful to find all patients with a specific cancer taking a specific medication. For a hospital, it may be useful to find all patients that required hospital readmission within 30 days of discharge after a specific diagnosis such as heart attack. For revenue cycle management, it may be useful to find the cohort of patients with a specific diagnosis or within a specific payer plan who were rejected for payment of a claim. Quality measures represent one potential characteristic to define a cohort or represent a partial definition of a cohort. Quality measures may be used in many health systems in many ways. Some health systems, such as the United States, define subsets of quality measures. As an example of a defined quality measure, for meaningful use compliance, it may be useful to find all patients within the cohort of smokers. For accountable care measures, it may be useful to find all patients within the cohort identified as complicated diabetics. Complicated diabetics may be a cohort which includes the intersection of other cohorts, such as diabetes and diabetes sequellae including retinopathy, nephropathy, and neuropathy.

In some embodiments, comparison of cohorts may be used to determine features associated with an individual being included versus excluded from a cohort. In some embodiments, associated features may be used to inform hospital administration. In some embodiments, associated features may be used to inform quality improvement practices. In some embodiments, associated features may be used to inform clinical care algorithms. In some embodiments, associated features may be used to inform other decisions related to patient care.

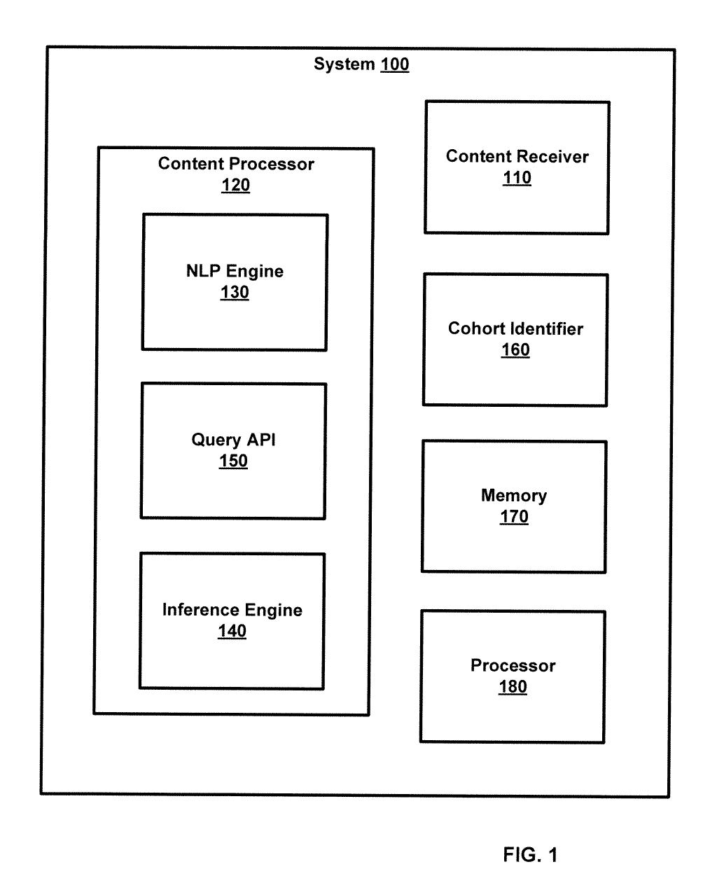

FIG. 1 illustrates a System 100 configured for processing data, according to various embodiments of the invention. System 100 may be configured in a single computing device or in a plurality of interconnected devices. For example, in some embodiments, System 100 includes a plurality of computing devices connected by a local area network, wide area network, or Internet. System 100 includes a Content Receiver 110, a Cohort Identifier 160, Memory 170, and a Processor 180, and a Content Processor 120 including an NLP Engine 130, an Inference Engine 140 and a Query API 150. These elements each include hardware, firmware and/or software stored on a non-transient computer readable medium. They each also include logic configured to perform specific functions as described elsewhere herein. This logic is embodied in the elements and includes hardware modified by computing instructions such that the hardware is configured to perform the specific functions.

Content Receiver 110 includes input/output hardware configured to receive data. For example, Content Receiver 110 may include an Ethernet port, a modem, a router, a firewall, microphone, recording device, and/or the like. In some embodiments, Content Receiver 110 includes logic configured to assure confidentiality of the received data. For example, the received data may include confidential medical data associated with a patient and Content Receiver 110 may include encryption or other tools configured to protect the confidentiality of this data. The data received by Content Receiver 110 is optionally received in data packets using standard file transfer protocols (FTP) or internet protocols (IP). The data received by Content Receiver 110 can include unstructured natural language data in the form of audio data and/or text data. Content Receiver 110 is optionally configured to receive data in real-time as the data is generated. For example, Content Receiver 110 may include a microphone configured to receive “live” audio data from a speaker in real time.

Content Processor 120 includes logic configured to process data received by Content Receiver 110. This logic is in the form of hardware, firmware and/or software stored on a non-transient computer readable medium. For example, Content Processor 120 may include computing instructions configured to be executed by Processor 180. These computing instructions may be used to convert Processor 180 from a general purpose microprocessor to a specific purpose microprocessor. Content Processor 120 optionally includes a voice to text converter (not shown) configured to convert received audio data to a textual representation.

The logic of Content Processor 120 includes NLP Engine 130, which is a natural language processing (NLP) engine. NLP Engine 130 is a machine component configured to convert unstructured national language data to structured data elements that are more easily operated on using a computing system such as System 100. NLP Engine 130 is configured to produce data elements in which meaning is derived from natural language context. Concepts found within the data elements are optionally aggregated such that relationships between the concepts can be annotated. The relationships may be based on, for example, a clinical model, an ontology and/or a lexicon. Further details of the operation of NPL Engine 130, according to some embodiments, can be found in co-pending U.S. application Ser. Nos. 13/929,236 and 14/003,790. However, NLP Engine 130 may include alternative natural language processing technology.

Query API 150 is configured to perform queries on data elements processed by NLP Engine 130. These data elements typically include one or more data elements derived from unstructured data, such as natural language data. As described further elsewhere herein, the results of the queries performed using Query API 150 may be used to determine that a patient belongs within one or more specific cohort. Query API 150 is optionally configured to operate on the data elements within a database using a query engine.

Inference Engine 140 is configured to create aggregations of concepts identified within the data elements processed by NLP Engine 130. These data elements typically include one or more data elements derived from unstructured data, such as natural language data. Inference Engine 140 is further configured to annotate relations between the concepts. The relationships can be based on one or more of a clinical model, an ontology, and/or a lexicon. The annotation is optionally stored in data records of a database including the data elements. Cohort Identifier 160 is configured to assess placement of a patient within one or more cohort. The placement is based on one or more unstructured data element associated with the patient. The placement may also be based on aggregations created by Inference Engine 140. In some embodiments, an output of Cohort Identifier 160 includes one or more probabilities that a patient falls within one or more cohorts, respectively.

Memory 170 is non-transient memory configured to store computing instructions and/or data. For example, Memory 170 may be configured to store any of the data operated on and/or produced by other elements of System 100. This data can include structured and unstructured patient data, audio data, aggregations, annotated data elements, etc. Data stored in Memory 170 is optionally stored in a database accessible using Query API 150.

Processor 180 is a microprocessor configured to execute computing instructions of the other elements of System 100 discussed herein. Processor 180 may operate on any of the data stored in Memory 170, under the control of these computing instructions. Processor 180 is programmed using these instructions to function as a specific purpose microprocessor

Methods for Assessing the Likelihood that a Patient Belongs within a Specified Cohort

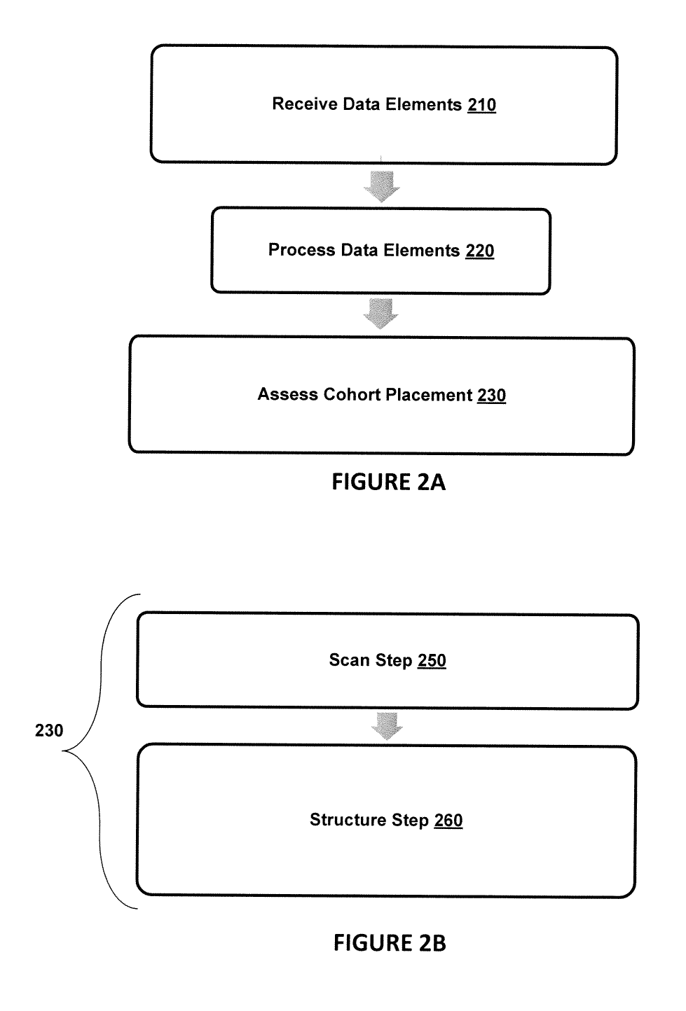

In general, as shown in FIG. 2A, the methods described herein for processing data in order to assess the likelihood that a patient belongs within a specified cohort may include a Receive Data Elements Step 210 in which a plurality of data elements is received from multiple data sets. Typically, one or more of the plurality of data elements are unstructured data elements. Receive Data Elements Step 210 is optionally performed using Content Receiver 110. The methods illustrated in FIG. 2A further include an optional Process Data Elements Step 220 in which unstructured members of the received data elements are processed. Process Data Elements Step 220 is optionally performed using Content Processor 120. Further details of Process Data Elements Step 220 are disclosed elsewhere herein, for example with respect to FIG. 2B. The methods illustrated in FIG. 2A further include an Assess Cohort Placement Step 230. Assess Cohort Placement Step 230 is optionally performed using Cohort Identifier 160. In Assess Cohort Placement Step 230 the likelihood that the patient belongs within a specified cohort is assessed using at least a portion of the plurality of data elements received in Receive Data Elements Step 210. The assertion is based on one or more data element that was originally unstructured data

In some embodiments, the specified cohort includes a negative characteristic or exclusion from a cohort. In some embodiments, the assessing step may be performed using a single data element. In some embodiments, multiple patients may be assessed concurrently or in series. In some embodiments, multiple cohorts may be specified concurrently or in series. In some embodiments, multiple patients and their placement into multiple specified cohorts may be assessed concurrently or in series. In some embodiments, the steps described are performed by different applications. In some embodiments, the steps described are performed by different vendors. In some embodiments, the set of patients may be defined by a physician, a hospital, a region, a diagnosis, an outcome, a patient characteristic, a care characteristic, a hospital characteristic, or a combination thereof.

In some embodiments, the unstructured data elements are received from one or more of an electronic health record, data warehouse, data repository, health information exchange, hospital data system, and non-hospital data system. In some embodiments, the methods described herein may leverage a combination of data elements from different sources in order to more efficiently and effectively identify cohorts.

In some embodiments, the multiple data sets may include discrete data elements, unstructured data elements, processed unstructured data elements, and/or a combination thereof. In some embodiments, the data elements may be received from data input sources, data storage sources, or a combination thereof. For example, at least a portion of the plurality of data elements may be processed unstructured data elements. The processed unstructured data elements may include patient encounter narratives entered from at least one of transcription, typed data entry, templated data entry, pen-based data entry, tablet based data entry, mobile data entry, or any other suitable data sources. Processed unstructured data may include unstructured data that has been mapped to a clinical model (post-coordinated content), data that has been mapped to a lexicon or ontology (pre-coordinated content), or a combination thereof. In some embodiments, at least a portion of the plurality of data elements are discrete data elements, and for example, the methods described herein may leverage a combination of discrete data elements and processed unstructured data elements in order to more efficiently and effectively identify cohorts. In these embodiments, the step of assessing the likelihood that a patient belongs within a specified cohort may include the step of determining if the combination of processed unstructured data elements and discrete data elements agree on patient placement within the specified cohort. The discrete data elements may include one or more of claims data, administrative data, EHR discrete data, hospital software system data, software system data from outside a hospital, and/or health information exchange data. In some embodiments, a portion of the discrete data elements may have been previously collected.

In some embodiments, data elements from different sources may contribute differently to the step of assessing the likelihood that the patient belongs within the specified cohort. For example, an algorithm may be used to weight the information provided by data elements from different sources or data sets. In some embodiments, the method may further include the step of using an algorithm to weight the data elements used to determine the likelihood that the patient belongs within the specified cohort. For example, processed unstructured data elements may be weighted higher than discrete data elements. Alternatively, processed unstructured data elements from a first source or data set may be weighted higher than processed unstructured data elements from a second source or data set. Alternatively, the various data elements may be weighted depending on any other suitable characteristic. In some embodiments, specific information within a given data stream may be weighted more heavily than other information. As an example, in assessing whether a patient belongs within a diabetic cohort, a discrete data item such as an ICD-9 code for diabetes may be heavily weighted whereas notation of high blood glucose within a narrative note may be weighted less heavily as there are many causes for high blood glucose beyond diabetes.

In some embodiments, a first likelihood of cohort placement may be assessed using a first portion of data elements, and a second likelihood of cohort placement may be assessed using a second portion of data elements. In some embodiments, the method may further include the step of using an algorithm to weight the assessed likelihoods that the patient is within a specified cohort, wherein likelihood was assessed based on a portion of the data elements. For example, within the unstructured data set, a blood pressure of 110/70 (normal) may be weighted low in diagnosing hypertension since any individual blood pressure is highly variable. However, within the same set, the words “high blood pressure” or the extracted code for hypertension may be weighted more heavily. The discrete code hypertension as selected by the physician for claim submission and residing within the discrete data set may be weighted heavily. In some embodiments, results from multiple data sets will lead to a score or likelihood that a patient is within or not within a given cohort.

Processing the Unstructured Data Elements

As shown in FIGS. 2A and 2B, the method may further include the optional step of Process Data Elements 220. At least a portion of the plurality of data elements processed includes unstructured data elements. Process Data Elements Step 220 is optionally performed using Content Processor 120. The assessing step, Assess Cohort Placement Step 230, may then include assessing the likelihood that the patient belongs within the specified cohort using at least one processed unstructured data element. The processing of an unstructured data element results in a structured data element having metadata or a data structure that characterizes the data element. This characterization can include assignment of the data element to a type, mapping, and/or relationship within a clinical model, an ontology and/or a lexicon. In some embodiments, as shown in FIG. 2B, Process Data Elements Step 220 a Scan Step 250 and a Structure Step 260. Scan Step 250 includes scanning the unstructured data elements using NPL Engine 130 to identify a plurality of concepts within a plurality of distinct contexts. Structure Step 260 includes structuring the unstructured data elements by creating aggregations of the concepts and annotating relationships between the concepts with at least one of a clinical model, an ontology, and a lexicon. Structure Step 260 is optionally performed using Inference Engine 140.

In some embodiments, Structure Step 260 includes structuring the unstructured data by mapping the data to the clinical model and providing post-coordinated content. In some embodiments, the step of structuring the unstructured data elements includes structuring the unstructured data by mapping the data to the ontology or lexicon and providing pre-coordinated content.

In some embodiments, Scan Step 250 and Structure Step 260 are data processing steps that transform data stored in Memory 170. In some embodiments, Scan Step 250 and Structure Step 260 are components of at least one of an application, a workflow, and a system. In some embodiments, Scan Step 250 and Structure Step 260 occur in real-time as input data is received at Content Receiver 110. Alternatively, Scan Step 250 and Structure Step 260 may be performed on data previously stored in Memory 170. In some embodiments, at least one of Scan Step 250 and Structure Step 260 occurs as a delayed process. In some embodiments, unstructured data associated with multiple patients is processed concurrently or in series. In some embodiments, multiple cohorts are specified concurrently or in series. In some embodiments, unstructured data associated with multiple patients is processed and their placement into multiple specified cohorts is assessed concurrently or in series. In some embodiments, the steps described herein are performed by different applications. In some embodiments, the steps herein described are performed by different vendors. The methods described herein, and the systems configured to perform them, may be a component of an application, workflow, or system. In some embodiments, the data are extracted and organized into a highly annotated document, data structure, or set of content that may be integrated directly with applications, such as applications addressing analytics, compliance, or revenue cycle management. In some embodiments, the application identifies patients to be included or excluded from a defined cohort. In some embodiments, the data structuring and cohort identification application are integrated.

In some embodiments, the methods described herein include an automated extraction of data from original documents including unstructured data elements in the form of unstructured clinical text. The extracted data may also provide insight into previously unusable unstructured content. In some embodiments, these data are extracted while annotating to a clinical model. In some embodiments, these data are extracted while coding to a lexicon, such as ICD-9. In some embodiments, these data are extracted while coding to an ontology, such as SNOMED. In some embodiments, a plurality of terminologies such as lexicons and ontologies may be used. In some embodiments, a combination of terminologies and clinical model may be used. This data extraction may be faster and more robust than manual data collection, saving time and money.

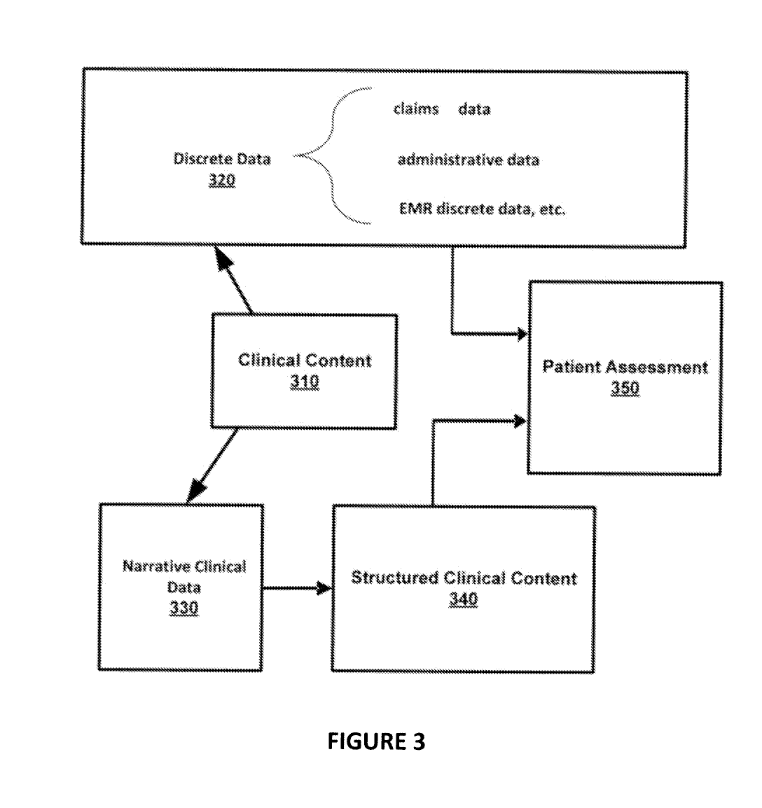

FIG. 3 illustrates a data flow as may occur during the methods illustrated in FIGS. 2A and 2B, according to various embodiments of the invention. The methods described herein for processing data in order to assess the likelihood that a patient belongs within a specified cohort may include the steps of receiving clinical content in the form of a plurality of data elements from multiple data sets, wherein at least a portion of the plurality of data elements are unstructured data elements; processing the unstructured data elements; and assessing the likelihood that the patient belongs within the specified cohort using at least a portion of the plurality of data elements including at least one processed unstructured data element. As shown in FIG. 3, Clinical Content 310 may be divided into Narrative Clinical Data 330 and Discrete Data 320. Narrative Clinical Data 330 may be from EMR, HIE, and other sources, and is typically unstructured data. Discrete Data 320 may be from one or a combination of claims data, administrative data, EHR discrete data, hospital software system data, outside hospital software system data, health information exchange data, or any other suitable discrete data source or form of discrete data. The Clinical Content 310 may be received in Receive Data Elements Step 210 (FIG. 2). As shown in FIG. 3, the Narrative Clinical Data 330 may be transformed to Structured Clinical Content 340. The Structured Clinical Content 340 is optionally fully annotated structured clinical content. This transformation is optionally performed using Process Data Elements Step 220 (FIG. 2). As shown in FIG. 3, the Discrete Data 320 and Structured Clinical Content 340 may both be used to generate a Patient Assessment 350. This can occur in Assess Cohort Placement Step 230 (FIG. 2). The Patient Assessment 350 represents a likelihood that a patient belongs within the specified cohort. It is obtained from at least a portion of Clinical Content 310 including both the Discrete Data 320 and Narrative Clinical Data 330.

As a specific example, Discrete Data 320 may include a field that further includes a notation that a patient is a smoker. This may have been entered years ago and may not be currently accurate. A recent narrative unstructured note (Narrative Clinical Data 330) may reference tobacco use. The combination of these data elements, drawn from the discrete data set the processed unstructured data set are highly suggestive that the patient currently belongs within the cohort of smokers. This information may lead to automatic assignment of a high likelihood score that the patient is included within the cohort of tobacco users.

Assessing the Likelihood of Cohort Placement

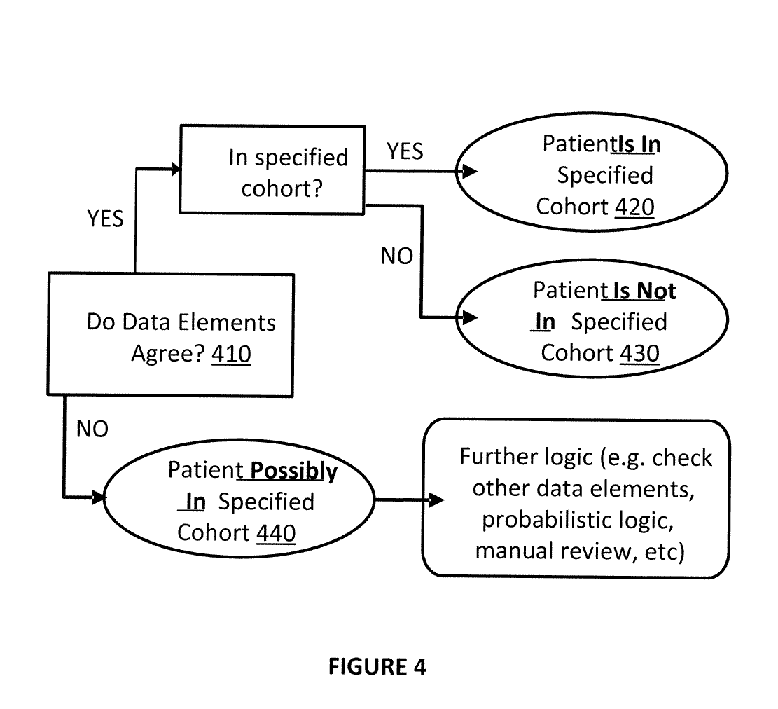

As described above in reference to FIGS. 2A, 2B and 3, the methods described herein include the step of assessing the likelihood that the patient belongs within the specified cohort using at least a portion of the plurality of data elements including at least one unstructured data element. FIG. 4 illustrates logic performed within the step of assessing the likelihood that a patient belongs within a specified cohort, e.g., Assess Cohort Placement Step 230. The logic includes determining if the data elements agree (410) on patient placement within the specified cohort. For example, as shown in FIG. 4, determining that the data elements agree on placement of the patient within the cohort may indicate that the patient should be placed within the cohort (420). Alternatively, as shown in FIG. 4, determining that the data elements agree on exclusion of the patient from the cohort may indicate that the patient should not be placed within the cohort (430). In some embodiments, also shown in FIG. 4, determining that the data elements do not agree on placement of the patient within the cohort may indicate that it is possible that the patient should be placed within the cohort (440).

As an example, a known complication for an operation may be infection. The specified cohort may be patients undergoing appendectomy diagnosed with surgical wound infection within the following 30 days. An unstructured data set may describe the appendectomy and may describe redness around the wound in subsequent follow up visit. Redness is a known sign of infection, but may be caused by other events, such as adhesive tape reaction. The patient would meet the inclusion criterion of appendicitis, but the other required inclusion criterion of diagnosed infection would be ambiguous. The patient has a sign of infection, but the diagnosis of infection is unclear based on the unstructured data. This may lead to a moderate likelihood of patient inclusion within the cohort.

As a further example, to place a patient within a cohort of active hypertension may require information from multiple data sources. A discrete data field within an EHR may include the item hypertension within a problem list. Recent clinical encounters may describe within the unstructured narrative that the patient has controlled hypertension and may have additional elements such as blood pressure 110/70, which is normal. The discrete data is suggestive that the patient has hypertension. The processed unstructured data is suggestive that the patient does not have active hypertension. The combination of these data elements may suggest that the patient's inclusion in the cohort is unknown. This unknown inclusion may lead to a manual review step to properly place the patient within our outside of the cohort.

In some embodiments, definitive identification within a cohort may require further logic. As shown in FIG. 4, when the data elements do not agree, the logic may include applying further logic to the plurality of data elements. This is optionally part of Assess Cohort Placement Step 230. In some embodiments, further logic may include applying additional logic, reviewing additional data, performing a manual review of ambiguous patients, applying probabilistic logic, other suitable operations, and/or a combination thereof. In some embodiments, the method may further include a sub-step of performing additional queries on existing data if the likelihood score does not clearly place the patient within or outside of the cohort. In some embodiments, the method may further include a sub-step of receiving a plurality of data elements from additional data sets. Alternatively, or additionally, the method may further include a sub-step of assessing the likelihood that the patient belongs within the specified cohort using a different portion of the plurality of data elements. In some embodiments, the method may further include a sub-step of performing a manual review if the data sets do not agree that the patient is within a specified cohort.

In some embodiments Assess Cohort Placement Step 230 includes determining a likelihood score that a patient belongs within a specified cohort. The score or likelihood may indicate that a patient should be included within or should be excluded from the specified cohort. In some embodiments, the method may further include the step of performing a manual review if the likelihood score does not clearly place the patient within or outside of the cohort. In some embodiments, the method may further include sub-steps of receiving a plurality of data elements from additional data sets and querying an additional data set if the likelihood score does not clearly place the patient within or outside of the cohort.

In some embodiments, Assess Cohort Placement Step 230 includes assessing the likelihood based on predetermined likelihood criteria. For example, the same patient as described above from the group of patients undergoing appendectomy diagnosed with surgical wound infection within the following 30 days, may also have information represented within discrete data. An item labeled wound infection on a submitted insurance claim related to a clinical visit shortly after the operation would be confirmatory and lead to a very high likelihood that the patient is included in the cohort. The workflow may allow for automatic placement of the patient within that cohort based on high likelihood or may require manual review.

The concept of assessment for cohort inclusion may also include the concept of assessment for cohort exclusion. For example, assessing for inclusion in a cohort of hypertensive patients may include assessment for inclusion in a cohort of non-hypertensive patients. Inclusion in the latter cohort is equivalent to exclusion from the former cohort. Items required for exclusion may be different from those required for inclusion. As an example, systolic blood pressure greater than 140 may be used as the criterion for inclusion in the hypertensive cohort. Inclusion in the non-hypertensive cohort may include systolic blood pressure equal to or less than 140, but may also include a requirement for no mention of the term hypertension or synonyms to hypertension within the recent patient record.

Querying a Portion of the Plurality of Data Elements

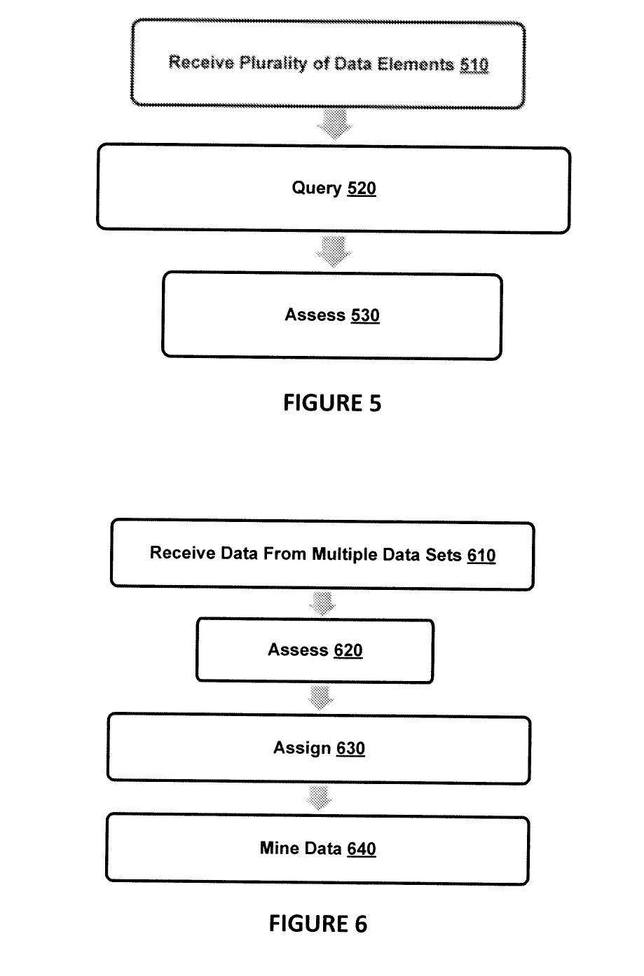

As shown in FIG. 5, a method for processing data in order to assess the likelihood that a patient belongs within a specified cohort may include a Receive Plurality of Data Elements Step 510. This step includes receiving a plurality of data elements from multiple data sets, wherein at least a portion of the plurality of data elements are unstructured data elements. The method further includes a Query Step 510. In Query Step 510 at least a portion of the plurality of data elements including at least one unstructured data element are queried. The method further includes an Assess Likelihood Step 530. This step includes assessing the likelihood that the patient belongs within the specified cohort. Query Step 520 may be performed to identify the specified cohort of patients, using Query API 150. In some embodiments, the method further includes a sub-step of querying data elements from multiple data sets to identify the specified cohort of patients. In some embodiments, Query Step 520 includes using similar query techniques on unstructured data elements, processed unstructured data elements, discrete data elements, or a combination of data elements from different data sources. In some embodiment, the method includes using different query techniques on processed unstructured data, discrete data, or a combination of data sources. In some embodiments, the method further includes a sub-step of querying a previously processed data set. In some embodiments, the method further includes a sub-step of building a query on data from a data warehouse or stored set of data. In some embodiments, the method further includes a sub-step of querying an index of a data warehouse or stored set of data.

In some embodiments, Query Step 520 includes querying the unstructured data element(s) using an ontology. For example, the ontology may be SNOMED. In some embodiments, Query Step 520 includes querying the unstructured data element(s) using an ontologic module. For example, the ontologic module may be a set of associated concepts within an ontology. In some embodiments, the method further includes a sub-step of querying the unstructured data set using term matching, for example using processed terms mapped to a lexicon. In some embodiments, the method further includes a sub-step of querying the unstructured data set using a lexicon. In some embodiments, the lexicon is ICD-9, ICD-10, RxNorm, LOINC, or a combination thereof. In some embodiments, Query Step 520 includes querying the unstructured data element(s) using at least one annotation within a clinical model.

In some embodiments, the method further includes a sub-step of querying the unstructured data set using a combination of at least one of keyword, lexicon, ontology, and clinical model annotation.

In some embodiments, Assess Step 530 and/or Assess Cohort Placement Step 230 include determining a probability that the data elements agree on patient placement within the specified cohort. In some embodiments, the portion of the data elements includes both unstructured data elements and discrete data elements. In this case, the determining step includes determining a probability that the unstructured data elements and the discrete data elements agree on patient placement within the specified cohort. In some embodiments, determining the probability that the data elements agree on patient placement within the specified cohort may also include the step of determining the probability that the patient should be placed within (or excluded from) the cohort. For example, determining that the data elements agree on placement of the patient within the cohort may indicate that the patient should be placed within the cohort. Alternatively, determining that the data elements agree on exclusion of the patient from the cohort may indicate that the patient should not be placed within the cohort. In some embodiments, determining that the data elements do not agree on placement of the patient within the cohort may indicate that it is possible that the patient should be placed within the cohort.

In some embodiments, Assess Step 530 and/or Assess Cohort Placement Step 230 include determining a likelihood threshold such that at least a portion of patients are automatically included within the specified cohort. Additionally, these steps may further include a sub-step of applying additional logic when a patient is not automatically included within or excluded from the specified cohort. In some embodiments, the sub-step of applying additional logic comprises using additional data elements to assess the likelihood that patients within the subset of patients belong within the specified cohort. In some embodiments, the sub-step of applying additional logic includes performing a manual review of a portion of the plurality of data elements associated with a subset of patients to assess the likelihood that patients within the subset of patients belong within the specified cohort. In some embodiments, the sub-step of applying additional logic may include performing an automatic review of a portion of the plurality of data elements when a patient is not automatically included within or excluded from the specified cohort.

Data Mining

The separation of patients or groups of patients into cohorts determined in part through processed unstructured data provides an opportunity to perform advanced data mining. In some embodiments, separation of cohorts by diagnosis or condition may offer the opportunity to align population-based management to that condition. As an example, a region with poor air quality may wish to identify all patients with asthma to implement an outpatient intervention to reduce asthma admissions. Some patients will be marked as having asthma in their discrete data, such as an EHR problem list, but many will only be noted to have asthma in the previous unused medical narratives.

As shown in FIG. 6, a method for processing data in order to assess the likelihood that a patient belongs within a specified cohort may include a Receive Data From Multiple Data Sets Step 610. In this step clinical data is received from multiple data sets, which may include data from different sources, data concerning different patients, and/or the like, wherein at least a portion of the plurality of data elements are unstructured data elements. The method also includes an Assess Step 620, which is similar to Assess Cohort Placement Step 230. Assess Step 620 includes assessing the likelihood that the patient belongs within the specified cohort using at least a portion of the plurality of data elements including at least one unstructured data element. Assess Step 620 is followed by an Assign Step 630 in which at least one patient is assigned to the specified cohort. Assess Step 620 is optionally performed using Cohort Identifier 160. As these steps are repeated for multiple patients, each assigned to cohorts, a statistically relevant set of clinical data is produced. This data, derived from many patients can be mined in a Mine Data Step 640.

In some embodiments, separation of cohorts by diagnosis or condition may offer the opportunity to define hospital or health system-based quality improvement interventions. As an example, a hospital may wish to identify high risk diabetics and target a campaign of glucose checks and medication usage support to reduce hospital admissions. Currently, finding high risk diabetics is difficult as there is no discrete dropdown in most EHRs to identify at risk diabetic only the concept of diabetes is usually labeled. On the other hand, the criteria for high risk diabetic are often noted in the unstructured notes, such as diabetes with kidney impairment.

In some embodiments, separation of cohorts by medication compliance may offer the opportunity to define hospital or health system-based compliance interventions. As an example, a hospital may wish to assure hypertensive patients are taking antihypertensive medications to reduce the risk for short or long term complications. The fact of non-compliance with medication may be found in a data feed separate from the EHR, such as pharmacy, or in a subject description of the patient by a nurse that is contained in the unstructured portion of a medical record.

In some embodiments, separation of cohorts by documentation features may offer the opportunity to support clinical document improvement. As an example, an EHR vendor may wish to support ICD-10 conversion and require identification of items needed in the narrative note to satisfy ICD-10 coding guidelines. The vendor may define a cohort for specific codes such as femur fracture where one cohort has body side and one does not. Since ICD-10 requires body side to complete this diagnosis code, the EHR may create a popup or other user interaction to request body side in real-time when the user types femur fracture or another term which normalizes to femur fracture, such as “fracture of the femur”. This would allow real-time addressing of ICD-10 conversion needs rather than an asynchronous process where a coder recognizes a needed item to meet ICD-10 requirements is missing and later contacts the physician to add the content. Normalization can be performed by Cohort Identifier 160 and/or Inference Engine 140.

In some embodiments, separation of cohorts by clinical features may offer the opportunity for clinical decision support. As an example, an EHR vendor may define the cohort young patients with anemia. When a physician attempts to prescribe blood transfusion, the EHR may identify the patient as belonging to the cohort of young patients with anemia where transfusion is inappropriate except in the case of severe anemia or active bleeding. If these circumstances do not apply, again based on algorithmic review of data sources including unstructured data, a clinical decision support warning could be initiated to warn against inappropriate use of transfusion.

In some embodiments, separation of cohorts by revenue cycle claim rejection may offer an opportunity to perform data mining on the rejected cohort to understand potential ways to avoid future claims rejection. As an example, data mining the rejected cohort versus the paid cohort may demonstrate features associated with rejection for a given payer. A specific payer may be found to consistently reject high risk diabetic patient encounter claims because the fact that they were high risk was not adequately documented.

In some embodiments, separation of cohorts by adverse events may offer an opportunity to determine factors associated with adverse events. As an example, a health system may wish to identify factors associated with deep vein thrombosis (DVT) after operation. Data mining the patient records of the DVT cohort versus the non-DVT cohort may reveal associated features that predominate in the DVT group. The administrators may find that in their institution, there is a higher than expected DVT rate and that this is associated with failure to properly risk stratify patients and follow national guidelines for DVT prophylaxis. Information relevant to national guidelines, such as weight and comorbidities, may exist only in the unstructured data and not in the discrete data.

In some embodiments, separation of cohorts by treatment algorithm may offer a researcher the opportunity to assess which treatment algorithms lead to preferred outcomes in specific circumstances. As an example, a researcher may wish to understand if a given medication leads to improved outcomes in pancreas cancer. The cohorts may include patients with pancreas cancer who survived versus those with pancreas cancer who suffered early death. Data mining each cohort to identify those treated with the medication under consideration may support demonstrating how this medication performs compared with other medications.

Data extracted by the methods described herein may provide a unique opportunity to query a hospital for patients with similar conditions, and to discover real-world clinical evidence advising optimal care. The methods described herein may have the capacity to repurpose informational byproducts of routine clinical documentation, acquiring usable data at much lower cost than otherwise possible. Data may be extracted from data stores to discover clinical correlates of utilization of healthcare and thereby predict high-utilization patients. The methods described herein may create models with improved predictive capabilities. The methods described herein may be used to build and implement a data warehouse absorbing structured and processed unstructured data sets and use queries to bring evidence derived from clinical documentation to treatment and administrative decisions. A query tool, as described herein, may allow for sophisticated matching of patient characteristics to the records of other patients in the database and support data mining, as described herein.

Once patients have been placed within or excluded from a cohort or set of cohorts, data mining of these patients to assess differences between cohorts is possible, e.g., using Mine Data Step 640. As a specific example, a plurality of data elements may be used in a manual or automated fashion to identify what common features exist within a cohort of patients that was readmitted to a hospital within 30 days. Those features may be compared with a cohort that was not readmitted. For example, 50-60 year old patients discharged with a cardiac condition and requiring readmission within 30 days may be compared with 50-60 year old patients discharged with the same cardiac condition and not requiring readmission within 30 days. Such comparison may yield actionable information associated with readmission. This type of cohort comparison may reveal specific features that potentially influence readmission. As an example, blood pressure on follow up clinic visit, whether a prescription was filled, response to follow up phone calls, or one or many other features or combination of features may be found to be associated with readmission. Intervention on these features may reduce readmission rate, thus leading to improved care and reduced costs. The outcome of readmission for that cardiac condition may be re-measured after an intervention to assess whether the outcome is improved and whether the intervention may be successful.

### CONCLUSION

Various embodiments of methods for processing unstructured data are provided herein. Although much of the description and accompanying figures generally focuses on methods that may be utilized with healthcare data sources such as EHRs, data warehouses, health information exchanges, in hospital data feeds, and out of hospital data feeds, in alternative embodiments, methods of the present invention may be used in any of a number of methods.

The examples and illustrations included herein show, by way of illustration and not of limitation, specific embodiments in which the subject matter may be practiced. Other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Computing systems referred to herein can comprise an integrated circuit, a microprocessor, a personal computer, a server, a distributed computing system, a communication device, a network device, or the like, and various combinations of the same. A computing system may also comprise non-transient volatile and/or non-volatile memory such as random access memory (RAM), dynamic random access memory (DRAM), static random access memory (SRAM), magnetic media, optical media, nano-media, a hard drive, a compact disk, a digital versatile disc (DVD), and/or other devices configured for storing analog or digital information, such as in a database. The various examples of logic noted above can comprise hardware, firmware, or software stored on a computer-readable medium, or combinations thereof. A computer-readable medium, as used herein, expressly excludes paper. Computer-implemented steps of the methods noted herein can comprise a set of instructions stored on a computer-readable medium that when executed cause the computing system to perform the steps. A computing system programmed to perform particular functions pursuant to instructions from program software becomes a special purpose computing system for performing those particular functions. Data that is manipulated by a special purpose computing system while performing those particular functions is at least electronically saved in buffers of the computing system, physically changing the special purpose computing system from one state to the next with each change to the stored data.

What is claimed is:

1. A method for processing data in order to assess the likelihood that a patient belongs within a specified cohort, the method comprising:
receiving a plurality of data elements from multiple data sets, wherein at least a portion of the plurality of data elements are unstructured data elements; and
assessing the likelihood that the patient belongs within the specified cohort using at least a portion of the plurality of data elements including at least one unstructured data element.

2. The method of claim 1, wherein non-inclusion in the specified cohort represents exclusion from the specified cohort.

3. The method of claim 1, wherein the unstructured data elements are from at least one of an electronic health record, data warehouse, data repository, health information exchange, hospital data system, and non-hospital data system.

4. The method of claim 1, wherein at least a portion of the plurality of data elements are discrete data elements.

5. The method of claim 1, wherein the step of assessing the likelihood that a patient belongs within a specified cohort comprises determining a likelihood score that a patient belongs within a specified cohort.

6. The method of claim 1, wherein the step of assessing the likelihood that a patient belongs within a specified cohort comprises determining if the data elements agree on patient placement within the specified cohort.

7. The method of claim 1, wherein the step of assessing the likelihood that a patient belongs within a specified cohort comprises determining that the patient is possibly within the specified cohort if the data elements do not agree on whether the patient is within a specified cohort.

8. The method of claim 1, wherein multiple patients are assessed concurrently.

9. The method of claim 1, wherein multiple cohorts are specified concurrently.

10. The method of claim 1, wherein the specified cohort includes a negative characteristic and is equal to exclusion from a related cohort.

11. The method of claim 1, further comprising the step of receiving a plurality of data elements from additional data sets if the data elements do not agree on whether the patient is within a specified cohort.

12. The method of claim 1, further comprising the step of performing a manual review of the data elements if the data elements do not agree on whether the patient is within a specified cohort.

13. A method for processing data in order to assess the likelihood that a patient belongs within a specified cohort, the method comprising:
receiving a plurality of data elements from multiple data sets, wherein at least a portion of the plurality of data elements are unstructured data elements; and
querying at least a portion of the plurality of data elements including at least one unstructured data element to assess the likelihood that the patient belongs within the specified cohort.

14. The method of claim 13, wherein the plurality of data elements queried includes at least one previously processed unstructured data element.

15. The method of claim 13, wherein the step of querying a portion of the plurality of data elements comprises querying the at least one unstructured data element using a combination of at least two of keyword, lexicon, ontology, and clinical model annotation.

16. A method for recognizing a set of associated concepts comprising the steps of:
scanning a set of narrative documents using a natural language processing (NLP) engine to identify a plurality of concepts; and
normalizing extracted concepts using a controlled vocabulary; and
determining actual and expected co-occurrence of potentially associated concepts; and
defining associations based on an algorithm that includes difference between actual and expected co-occurrence

17. The method of claim 16, wherein the algorithm includes at least one unstructured data element.

18. The method of claim 16, wherein a concept may be associated with a cluster of concepts.

19. The method of claim 16, wherein a support coefficient such as a numerical or categorical representation represents the strength of association between a concept and a cluster of concepts.

20. The method of claim 16, wherein the processed unstructured data elements comprise patient encounter narratives entered from at least one of transcription, typed data entry, templated data entry, pen-based data entry, tablet based data entry, and mobile data entry.
